(19) United States
(12) Patent Application Publication
(10) Pub. No.: US 2002/0073749 A1
(43) Pub. Date: Jun. 20, 2002

(54) Steering wheel security device

(76) Inventor: Spencer L. Turknett, Caxton, TX (US)

Correspondence Address: Richard C. Litman, LITMAN LAW OFFICES, LTD., P.O. Box 15035, Arlington, VA, 22215, US

(21) Appl. No.: 09/994,677

(22) Filed: Nov. 28, 2001

Related U.S. Application Data
(60) Provisional application No. 60/253,101, filed on Nov. 28, 2000.

(51) Int. Cl. B60R 25/02

(52) U.S. Cl. 70/209

(57) ABSTRACT

A steering wheel security system which includes in combination a lock mechanism and a steering wheel cap. The cap has a first and second steering wheel covering portion for selectively preventing access to operative mechanisms disposed in and around the steering wheel and column. The first portion has a first and second flange with at least one aperture for frictionally abutting and aligning with a respective mating flange disposed on a first and second portion of the second steering wheel covering portion. Each first and second cap elements are matingly attached and aligned in such a way for insertably receiving the attachment of a locking mechanism. The steering wheel covering portions are hollow in construction and substantially C-shaped. When completely configured, the security system operatively forms male and female interconnected portions surrounding a steering wheel and associative controls.

### CROSS-REFERENCE TO RELATED APPLICATION

This application claims the benefit of U.S. Provisional Patent Application Serial No. 60/253,101, filed Nov. 28, 2000.

### BACKGROUND OF THE INVENTION

1. Field of the Invention

The present invention relates generally to steering wheel security devices. More specifically, the invention is a steering wheel security plate or cap system which completely encloses a steering wheel for immobilizing vehicles via the steering wheel and related controls.

2. Description of Related Art

Numerous automotive ant-theft devices have been devised to provide a first level of defense against would be criminals. However, none of the conventional devices teach a security device which utilizes a cover or cap and lock combination for isolating and securing a steering wheel as herein described.

For example, U.S. Pat. No. 4,589,513 issued to Proffitt discloses a anti-theft steering wheel adapter which includes an open topped housing, the bottom of which is interconnectable to a vehicle steering column through an adapter plate. A biasing plate is slidably supported in a horizontal position in the housing on a number of spaced vertical posts which are secured to a base plate in the housing. The biasing plate bears a number of spaced ridges extending up from the periphery thereof and defining peripheral recesses therebetween. A horizontal ring locking plate is fixed to the top of the posts above the biasing plate and bears a spaced teeth which defines a number of notches. Coiled springs on the posts push up the locking plate for subsequently securing the biasing plate to the locking plate via a key-lock mounted in the housing.

Other devices include special locking mechanism which are distinctly mounted within the column of the steering wheel for rapid interlocking and/or disengagement with the steering wheel. Patents issued and respectively granted to Malvy et al. (U.S. Pat. No. 4,659,244), Usina (U.S. Pat. No. 4,934,479), Mertens et al. (U.S. Pat. No. 5,152,363), Rosenlund (U.S. Pat. No. 5,180,029), Malvy (EP 0203850), Carli (EP 0210324) and Ramsay (EP 0276565) are of this type. The steering wheel security device as herein described is a removable device which is not structurally fixed as taught by these conventional steering wheel locking features.

U.S. patents issued to LiCausi (U.S. Pat. No. 5,566,560) and Graham (U.S. Pat. No. 5,826,448) disclose an air-bag type anti-theft device capable of engaging a central portion of a steering wheel containing an air bag device. In the latter instance, a U-shaped locking device having a handle straddles an interior portion of the steering wheel with bottom and top attachments to the column. The top attachment mechanism for the locking device is via key locking mechanism, however, there is still some movement of the steering column including access to certain controls in and around the steering wheel attached thereto.

U.S. Pat. No. 5,113,674 issued to LiCausi discloses a an anti-theft device comprising a yoke member adapted to be positioned on the steering column. The yoke member includes a key housing shield adapted to cover and protect the key housing on the steering column when the device is mounted in place. A bent bracket is also used having one end adapted to be mounted to the yoke member and another end adapted to engage with a spoke of the wheel which prevents rotation in a predetermined direction when secured as a single integrated bracket and yoke assembly.

U.S. patents issued to Noel (U.S. Pat. No. 5,461,891) and Briones (U.S. Pat. No. 5,697,235) disclose anti-theft devices for secure positioning over and around a steering wheel column. In particular, the device described by Noel comprises a plate positionable over a top central part of a conventional steering wheel. The plate has a short post extending downwardly from one edge thereof with an upper end pivotally secured an axis with respect to the plate and with the lower end having an inwardly projecting leg. The plate also has a long post which extends downwardly from a second edge of the plate diametrically opposite from the first edge with an upper end pivotally secured about an axis with the first axis and with a lower end having an outwardly projecting leg. In both instances, a projecting leg portion is secured to a divided first and second housing mounted to the column.

U.S. Pat. No. 5,724,838 issued to Alicea discloses an anti-theft device which operatively connects to three distinct locations for automobile immobilization. The device comprises a clamp mounted in a releasable manner to a steering wheel with a bracket pivotally extending therefrom for releasable connection with a brake pedal. A cover is coupled to the clamp and is releasably affixed about a steering column.

None of the above inventions and patents, taken either singly or in combination, is seen to describe the instant invention as claimed.

### SUMMARY OF THE INVENTION

The steering wheel security system according to the invention includes in combination a lock mechanism and a steering wheel cap. The cap has a first and second steering wheel covering portion for selectively preventing access to operative mechanisms disposed in and around the steering wheel and column. The first portion has a first and second flange with at least one aperture for frictionally abutting and aligning with a respective mating flange disposed on a first and second portion of the second steering wheel covering portion. Each first and second cap elements are matingly attached and aligned in such a way for insertably receiving the attachment of a locking mechanism. The steering wheel covering portions are hollow in construction and substantially C-shaped. When completely configured, the security system forms male and female interconnected portions surrounding a steering wheel and associative elements.

Accordingly, it is a principal object of the invention to provide a steering wheel security system which deters automobile theft.

It is another object of the invention to provide a steering wheel security system which protects on board steering wheel controls from vandalism or damage.

It is a further object of the invention to provide a steering wheel security system which renders the steering wheel and related controls virtually inoperable in a secured state.

Still another object of the invention is to provide a steering wheel security system which is simple to deploy and disassemble.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a steering wheel security device according to the present invention.

FIG. 2 is an exploded perspective view of the steering wheel security system according to the present invention.

Similar reference characters denote corresponding features consistently throughout the attached drawings.

### DETAILED DESCRIPTION OF THE PREFERRED EMBODIMENT

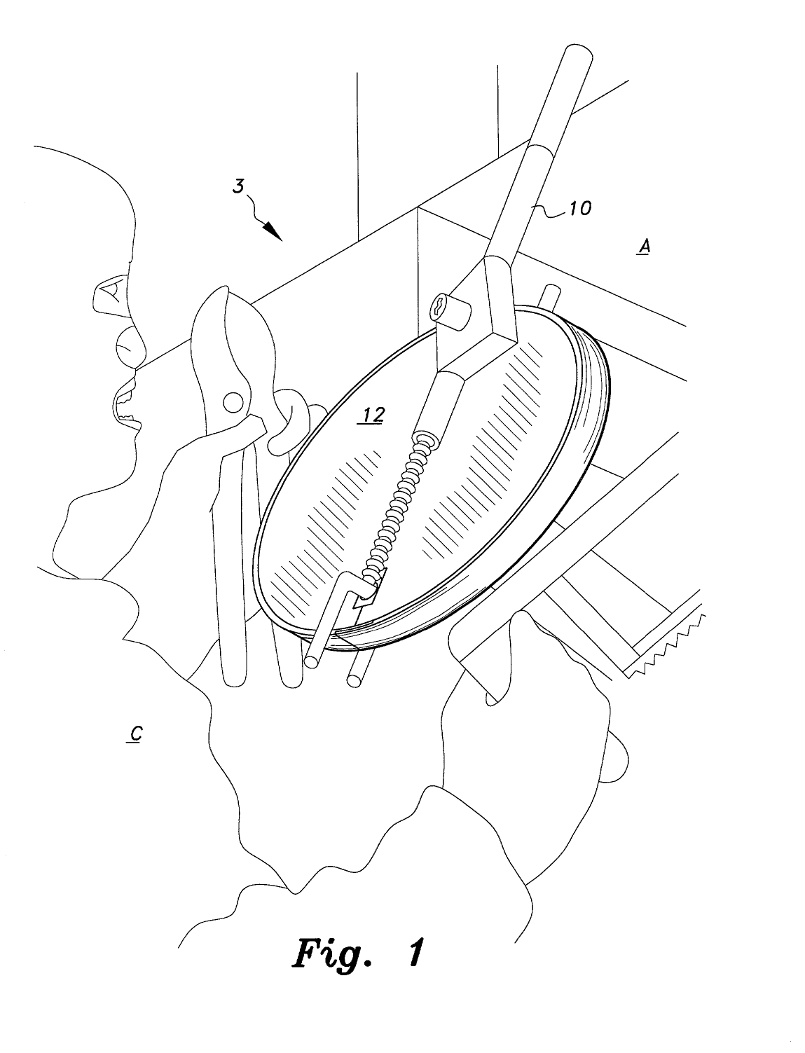

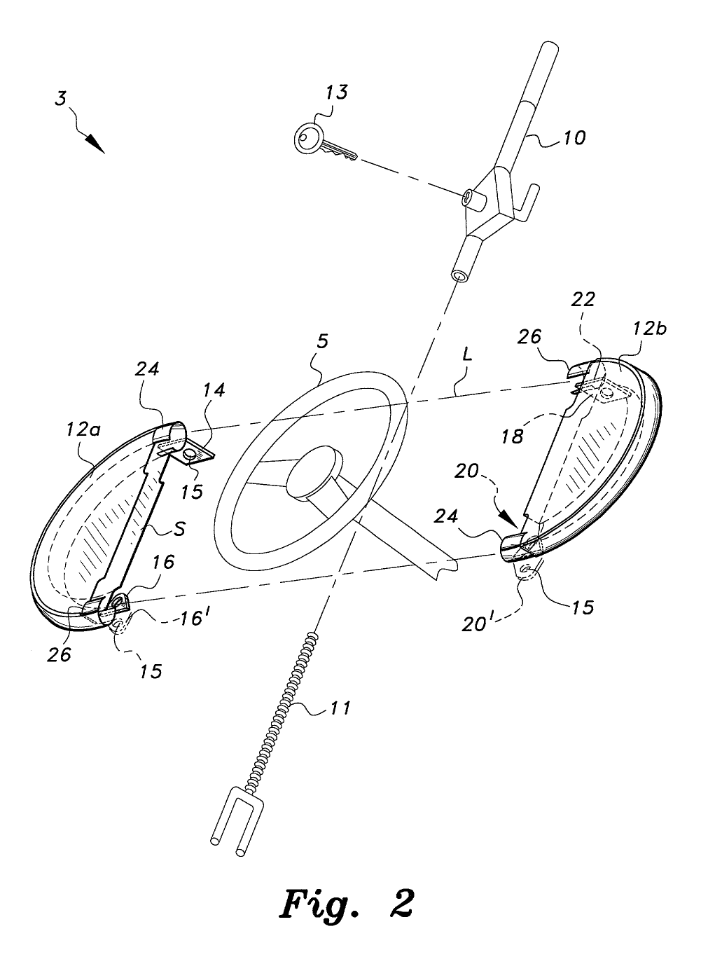

The present invention is directed to an anti-theft steering wheel security system for automobiles A. The preferred embodiment of the present invention is depicted in FIGS. 1 and 2, and is generally referenced by numeral 3.

As diagrammatically illustrated in FIGS. 1 and 2, the security system 3 renders a would be criminal C frustrated and unsuccessful in manipulating a steering wheel 5 and related controls which enables car theft. The system 3, as shown therein, comprises in combination a lock mechanism 10 and a steering wheel cap 12. Numerous locking mechanisms can be used and are available as a single or integral locking mechanism 10. The type of lock 10 which is shown as an exemplary locking mechanism 20 is one having an insertable rod 11 which enables the locking of channels through a first and second flange via a key 13 as further discussed below. The cap 12 is shown having two primary parts composed of a first 12a and second 12b steering wheel covering portion. The first portion 12a has a first 14 and second 16 flange with at least one aperture 15 for frictionally abutting and aligning with a respective mating flange 18,20 disposed on a first 22 and second 24 portion, respectively of the second steering wheel covering portion 12b. When configured as a single entity, the cap 12 is aligned as integrated mating elements 12a and 12b for insertably receiving the locking mechanism 10 through properly aligned apertures 15 disposed therein. The flanges 14, 16, 18 and 20, respectively can be made to protrude vertically with respect to a planar surface S or horizontally or parallel thereto as shown by the horizontal orientation of flanges 16 and 20 (and perpendicular by flanges 16′, 20′, 14 and 18, respectively). Either configuration can be used depending on the type of locking mechanism desired or utilized by an owner to secure the anti-theft device according to the invention.

As further shown in detail, the security system 3 according to FIG. 2 includes wherein the first 12a and second 12b steering wheel covering portions are substantially C-shaped and hollow covering portions. These particular features have been found to simplify the deployment of the system 3 with added security or protection from possible destruction of key controls for starting and operating vehicles. This is particularly important in instances where a single parent having one vehicle can easily complete the day without delays directly related to needed car repairs from vandalism.

Accordingly, the C-shaped and hollow first 12a and second 12b steering wheel covering portions interconnect as male 24 and female 26 interconnected steering wheel covering portions. For example, elements 14 and 18 are directed for mating attachment along line L. operatively, element 18 abuts with element 14 until the apertures 15 are perfectly aligned (similarly for flanges 16 and 20). The male 24 and female 26 can be arranged in any desired configuration, that is the first cap portion 12a can be configured solely with male 24 connectors or a combination of both male 24 and female 26 connectors (likewise for the second cap portion 12b). The other advantages of the instant invention are wherein the cap 12 is made of material which is durable to protect against cyclical stresses which produces material fatigue and which is resistant to rust and corrosion. These materials can include composite plastics, nylon, stainless steel, aluminum, etc.

It is to be understood that the present invention is not limited to the sole embodiment described above, but encompasses any and all embodiments within the scope of the following claims.

I claim:

1. A steering wheel security system comprising:
a steering wheel cap, said cap comprising a first and second steering wheel covering portion, the first portion having a first and second flange with at least one aperture for frictionally abutting and aligning with a respective mating flange disposed on a first and second portion of the second steering wheel covering portion for insertably receiving a locking mechanism.

2. The security system according to claim 1, wherein said first and second steering wheel covering portions are substantially C-shaped and hollow covering portions.

3. The security system according to claim 2, wherein said C-shaped and hollow first and second steering wheel covering portions interconnect as male and female interconnected steering wheel covering portions.

4. The security system according to claim 2, wherein said first steering wheel covering portion is a male type connecting portion.

5. The security system according to claim 2, wherein said second steering wheel covering portion is a female type connecting portion.

6. The security system according to claim 1, wherein said cap is made of a durable material. second steering wheel covering portion is a female type connecting portion.

7. The security system according to claim 1, wherein said material is resistant to rust and corrosion.

8. A steering wheel security system comprising, in combination with a lock mechanism:
a steering wheel cap, said cap comprising a first and second steering wheel covering portion, the first portion having a first and second flange with at least one aperture for frictionally abutting and aligning with a respective mating flange disposed on a first and second portion of the second steering wheel covering portion for insertably receiving the locking mechanism.

9. The security system according to claim 8, wherein said first and second steering wheel covering portions are substantially C-shaped and hollow covering portions.

10. The security system according to claim 9, wherein said C-shaped and hollow first and second steering wheel covering portions interconnect as male and female interconnected steering wheel covering portions.

11. The security system according to claim 9, wherein said first steering wheel covering portion is a male type connecting portion.

12. The security system according to claim 9, wherein said second steering wheel covering portion is a female type connecting portion.

13. The security system according to claim 8, wherein said cap is made of a durable material.

14. The security system according to claim 8, wherein said material is resistant to rust and corrosion.
